(19) United States
(12) Patent Application Publication
(10) Pub. No.: US 2017/0202198 A1
(43) Pub. Date: Jul. 20, 2017

(54) THERAPEUTIC HORSESHOE

(71) Applicant: JASON SMITH, RATCLIFF, AR (US)

(72) Inventor: JASON SMITH, RATCLIFF, AR (US)

(21) Appl. No.: 14/995,963

(22) Filed: Jan. 14, 2016

(51) Int. Cl. A01L 1/02; A01L 7/10; A01L 1/04

(52) U.S. Cl. CPC A01L 1/02; A01L 1/04; A01L 7/10

(57) ABSTRACT

A horseshoe has a toe adjoining to two branches that bend away from the toe and terminate in a heel, an at least partially planar top surface of the adjoined toe and two branches, and an at least partially planar bottom surface of the adjoined toe and two branches. The top surface and bottom surface are angled together such that they are closer in proximity at the heel than the toe.

### FIELD OF THE INVENTION

This disclosure relates to horseshoes in general and, more particularly, to metallic horseshoes for treating certain hoof conditions.

### BACKGROUND OF THE INVENTION

Part of a farrier's task in shoeing horses is to shape and contour the hoof using various rasps, files, knives or other implements before applying the metallic shoe. The hoof may be trimmed, filed, or otherwise shaped such that the leg and foot bones of the horse are placed in an ideal anatomical position commensurate with the physical demands placed on the animal.

In some cases, the hoof cannot be adequately trimmed or shaped to achieve a desired foot position before placing the shoe. Normally, the primary concern is with placing the coffin bone wings 3 to 8 degrees higher than the frontal portion or toe of this bone. Various implements known as wedge pads have been devised to be placed between the trimmed hoof and a metallic shoe to correct this angle. However, these add complexity to the job of shoeing and the pads themselves can cause complications with regard to the hoof, including bacterial growth. Furthermore, such combinations of existing horseshoes and wedge pads do nothing to address instances where hoof or bone anatomy leads to the situation where the heel (wing bones) or back end of the foot is overly elevated compared to the toe or front of the hoof.

What is needed is a device and method for addressing the above, and related, issues.

### SUMMARY OF THE INVENTION

The invention of the present disclosure, in one aspect thereof, comprises a horseshoe having a toe connecting to two branches that arc toward a heel, a top of the toe and two branches providing a mating surface for contacting an equine hoof, and a bottom of the toe and two branches defining a recessed trench and plurality of tack holes inside the trench passing through the branches to the top. The top and bottom are planar along at least a portion thereof and the top is angled away from the bottom from heel to toe at a continuous predetermined angle.

In some embodiments, the predetermined angle is about 1 degree. In other embodiments it may be about 2 degrees, or about 3 degrees. The trench may be defined through both branches and the toe. The shoe may include a wear plate placed into the trench at the toe, and the wear plate may comprise a different material than the rest of the horseshoe.

The invention of the present disclosure, in another aspect thereof, comprises a horseshoe having a toe adjoining to two branches that bend away from the toe and terminate in a heel, an at least partially planar top surface of the adjoined toe and two branches, and an at least partially planar bottom surface of the adjoined toe and two branches. The top surface and bottom surface are angled together such that they are closer in proximity at the heel than the toe.

In some embodiments, the top surface and bottom surface are angled together at least one degree. In other embodiments, the top surface and bottom surface are angled together at least two degrees or at least three degrees.

The invention of the present disclosure, in another aspect thereof, comprises a method including preparing a hoof to accept an equine shoe, providing a shoe comprising a top surface, a bottom surface, a toe and a heel, the top surface adapted to fit the hoof and the top and bottom surface being angled toward one another at a predetermined angle to be closer together at the heel than the toe, and fixing the shoe to the hoof.

In various embodiments, providing the shoe comprises providing a shoe with a predetermined angle of about 1 degree, 2 degrees, or 3 degrees. Fixing the shoe to the hoof may comprise nailing the shoe to a keratinized portion of the hoof, and providing a shoe may further comprise providing a shoe with a trench cut into the bottom surface and defining a plurality of nail holes.

### BRIEF DESCRIPTION OF THE DRAWINGS

FIG. 1 is a simplified anatomical cross section of an equine hoof.

FIG. 2A is an inferior plan view of one embodiment of a therapeutic horseshoe according to aspects of the present disclosure.

FIG. 2B is a superior plan view of the horseshoe of FIG. 2A.

FIG. 2C is a side view of the horseshoe of FIG. 2A.

FIG. 2D is a side view of the horseshoe of FIG. 2A opposite of FIG. 2C.

FIG. 3 is a perspective view of the bottom of the horseshoe of FIG. 2A.

FIG. 4A is an inferior plan view of one embodiment of a therapeutic horseshoe according to aspects of the present disclosure in size 00.

FIG. 4B is a superior plan view of the horseshoe of FIG. 4A.

FIG. 4C is a side view of the horseshoe of FIG. 4A.

FIG. 4D is a side view of the horseshoe of FIG. 4A opposite of FIG. 4C.

FIG. 4E is a side cutaway view of the horseshoe of FIG. 4A.

FIG. 5A is an inferior plan view of one embodiment of a therapeutic horseshoe according to aspects of the present disclosure in size 0.

FIG. 5B is a superior plan view of the horseshoe of FIG. 5A.

FIG. 5C is a side view of the horseshoe of FIG. 5A.

FIG. 5D is a side view of the horseshoe of FIG. 5A opposite of FIG. 5C.

FIG. 5E is a side cutaway view of the horseshoe of FIG. 5A.

FIG. 6A is an inferior plan view of one embodiment of a therapeutic horseshoe according to aspects of the present disclosure in size 1.

FIG. 6B is a superior plan view of the horseshoe of FIG. 6A.

FIG. 6C is a side view of the horseshoe of FIG. 6A.

FIG. 6D is a side view of the horseshoe of FIG. 6A opposite of FIG. 6C.

FIG. 6E is a side cutaway view of the horseshoe of FIG. 6A.

FIG. 7A is an inferior plan view of one embodiment of a therapeutic horseshoe according to aspects of the present disclosure in size 2.

FIG. 7B is a superior plan view of the horseshoe of FIG. 7A.

FIG. 7C is a side view of the horseshoe of FIG. 7A.

FIG. 7D is a side view of the horseshoe of FIG. 7A opposite of FIG. 7C.

FIG. 7E is a side cutaway view of the horseshoe of FIG. 7A.

### DETAILED DESCRIPTION OF THE PREFERRED EMBODIMENTS

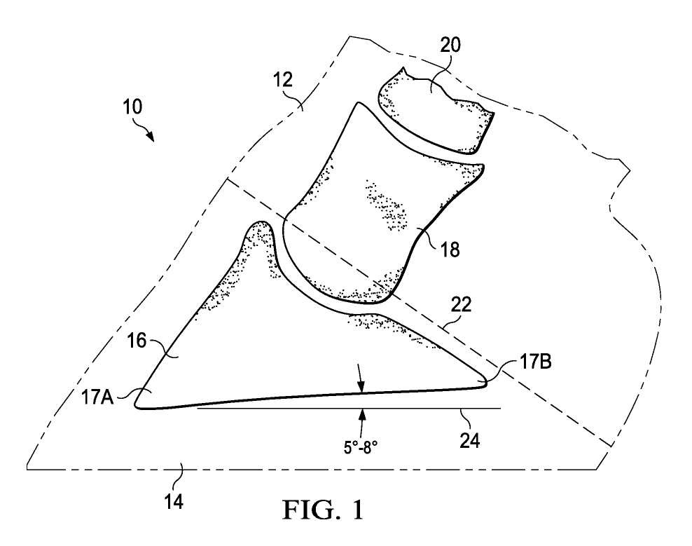

Referring now to FIG. 1, a simplified anatomical cross section of an equine hoof is shown. The hoof 10 grows from a horse's leg or foot 12. A keratinized wall structure 14 is demarcated from the foot by coronet band 22. Internal to the wall 14 is a coffin bone 16, which has a toe 17A on the fore end and splits into a pair of wings 17B rearwardly. Nested into the coffin bone 16 is the short pastern bone 18 followed by the long pastern bone further up the leg. It should be understood that the represented anatomy is very simplified and those of skill in the art will have much greater knowledge of anatomy and mechanics that that presented here. Nevertheless, FIG. 1 illustrates a physiological parameter of importance—that being the angle the coffin bone 16 makes with respect to the horizontal. Ideally, the coffin bone 16 is supported or maintained (by the hoof wall 14 and/or a shoe) at a downward angle of about 5° to about 8°.

Normally, when a healthy horse bears only its own weight, and experiences a normal range of activity on natural surfaces, the hoof walls 14 grow out and wear down at approximately the correct rate to provide the ideal natural angle of 5° to 8° for healthy function. However, a domesticated horse that may bear the weight of a rider, pull a wagon, or perform other work will wear the hooves more quickly and perhaps unevenly for purposes of maintaining ideal foot health and bone angle. Moreover, unnatural surfaces such as asphalt and concrete exacerbate this problem. Horseshoes were developed centuries ago to provide protection for the hoof and increase the amount of work a horse can safely perform.

Horseshoes are typically only flat (though cleats or implements may be provided at the rear of the shoe for enhanced traction). The farrier may safely trim the hoof such that correct anatomical positioning of the hoof and bones are maintained even where the shoe is flat. In the past, adjustment beyond what was achievable by trimming the hoof was achieved by wedge pads to be placed between the hoof and shoe when the shoe was fitted. However, as discussed above, these are not without problems of their own and can be far from ideal. Furthermore, such combinations of existing horseshoes and wedge pads do nothing to address instances where hoof or bone anatomy leads to the situation where the heel (e.g., wing bones 17B) is overly elevated compared to the toe 17A.

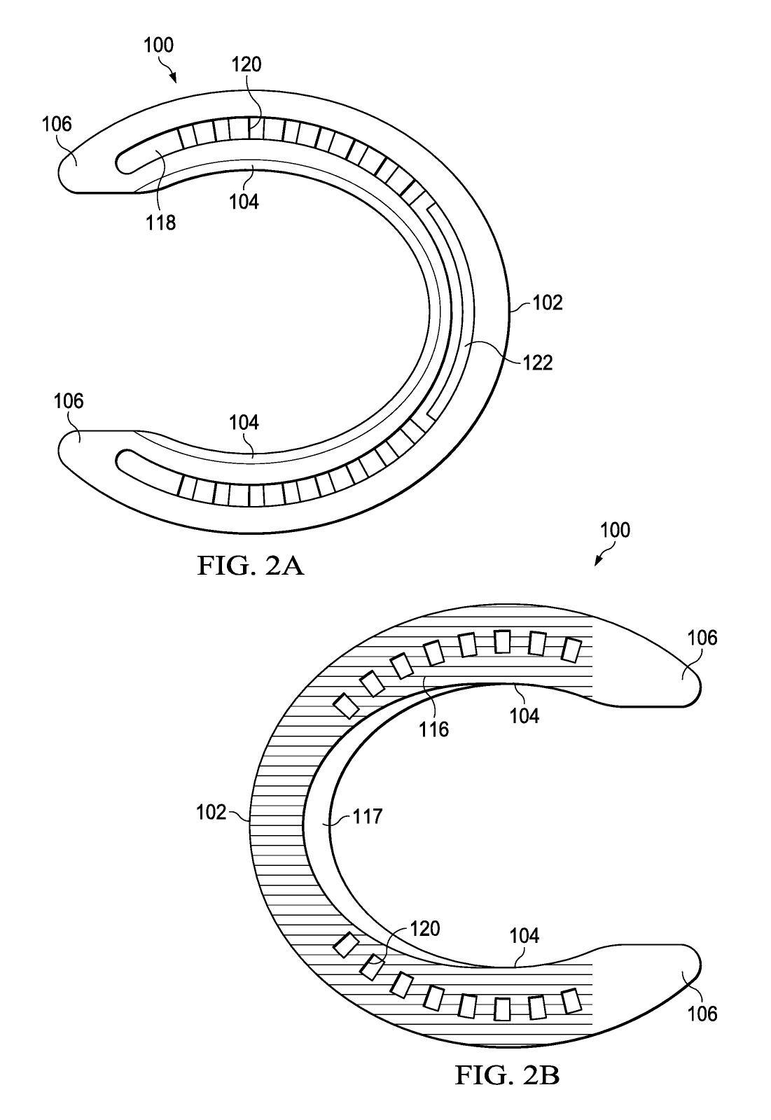

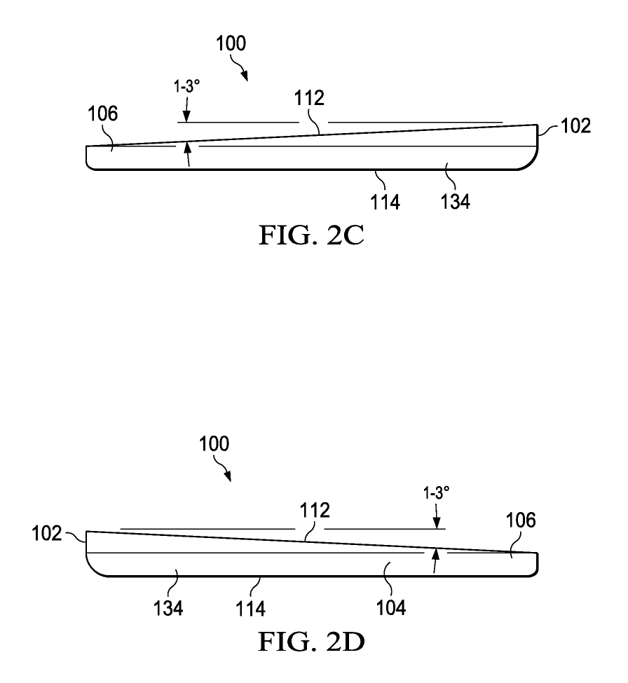

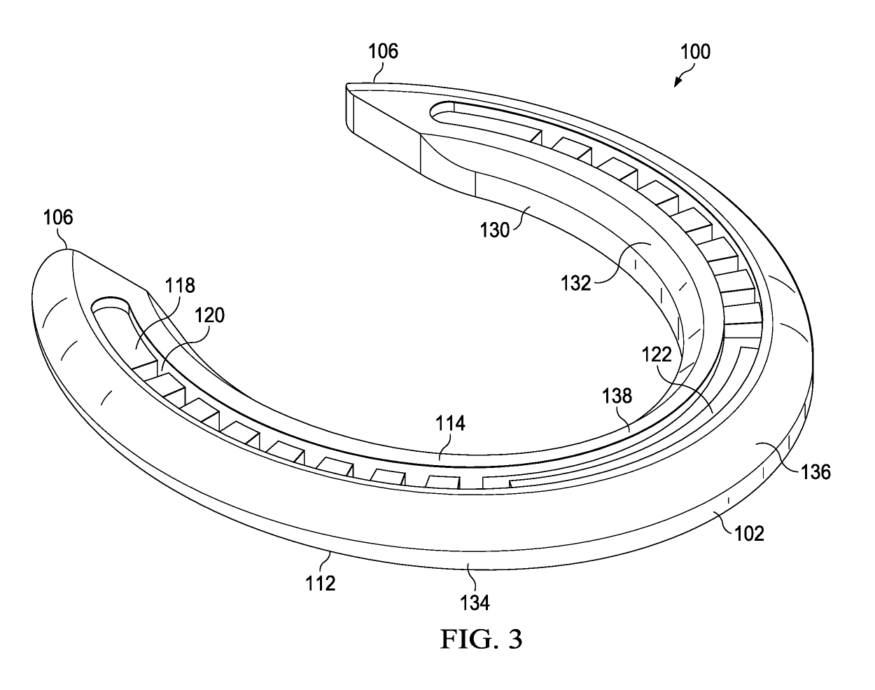

Referring now to FIG. 2A an inferior plan view of one embodiment of a therapeutic horseshoe 100 according to aspects of the present disclosure is shown. A superior plan view is shown in FIG. 2B, while opposite side views are shown in FIGS. 2C and 2D. FIG. 3 is a perspective view of the horseshoe of FIGS. 2A-2D shown from the bottom surface—that is the surface that contacts the ground when the horseshoe is installed. These drawings should be considered together as representing the same embodiment of a therapeutic horseshoe according to aspects of the present disclosure.

The horseshoe 100 comprises a toe 102 that curves into two branches 104, each terminating in a heel 106. When fitted to the hoof of a horse, the toe 102 corresponds to the toe or front of the hoof while the branches 104 proceed along the outer edge or wings of the hoof. The horseshoe 100 comprises an outer edge 108 and an inner edge 110. Defined between these edges, on a top 112 of the shoe 100, is a mating surface 116. The mating surface 116 is fitted to the hoof of a horse during installation. The mating surface 116 may be textured or roughened in order to provide a fit to the hoof that is less likely to slip during installation of the horseshoe 100 or in subsequent use. In some embodiments, a portion of the top 112 may be recessed in an area known as the toe ramp 117. This may be for weight reduction or where the mating surface 116 is simply not needed where the toe of the hoof is not as wide as the sides.

On an opposite side of the horseshoe 100 from the top 112 and mating surface 116 is a bottom surface 114. The bottom surface 114 may be generally planar, or planar with rounded edges, and provide additional features. Following the general shape of the horseshoe 100 and occupying the toe 102 and possibly portions of one or both branches 104 is a trench 118. The trench 118 may be a molded or machined recess in the bottom surface 114 of the horseshoe 100. A number of openings or tack holes 120 may be defined within the trench 118. The tack holes 120 may pass from the trench 118 in the bottom 114 through to the top 112 of the horseshoe 100. The tack holes may be square in shape to mate with horseshoe nails that may also have a square cross section. The nails (not shown) are hammered through the tack holes 120 and out the sides of the wing of the hoof (e.g., the hoof walls 14 of FIG. 1) for secure attachment. The trench 118 allows the nails or tacks to be countersunk into the horseshoe 100 for protection and durability of the installation. The trench 118 can also provide additional traction to the animal wearing the horseshoe 100 since the horseshoe may otherwise comprise a relatively slick metal with rounded edges.

Within the trench 118, near the toe 102, a wear plate 122 may be provided. The wear plate 122 may be flush with the top 112 or may be slightly countersunk. The wear plate 122 may comprise a different material (e.g., steel, where the rest of the shoe 100 is aluminum) to alter or improve the wear characteristics of the horseshoe 100.

With particular reference now to FIGS. 2C and 2D, a critical aspect of the present embodiment of the disclosure can be appreciated. Rather than the top 112 and bottom 114 being level, or parallel to one another, the top 112 angles downward from the heel 106 to the toe 102. The degree of angle is about 3° in one embodiment. In another embodiment, the angle is about 2°, and in a further embodiment, the angle is about 1°. It will be appreciated that horseshoes could be constructed according to the present embodiment that have angles that are not 1°, 2°, or 3° but some intermediate angle, such as 2.5°. However, even where a hoof is compromised, a farrier can generally adjust the hoof prior to shoe fitting such that one of these particular angles will work well for correctly aligning the bones of the horse's foot for optimum health.

In some embodiments, the bottom 114 of the horseshoe 100 angles toward the top—and the effect when installed will be similar to one where the top is angled relative to the bottom. In further embodiments, both top 112 and bottom 114 may angle together such that the total angle between them adds up to the 1°-3° discussed above.

With particular reference now to FIG. 3, certain aspects of the construction of the horseshoe 100 can be more easily appreciated. Along the “outside” of the horseshoe 100 is an outer wall 134. The outer wall 134 can be seen to taper toward the heel 106 of each branch 104 to account for the angle between the top 112 and bottom 114. A radius 136 around the outside bottom edge of the horseshoe may join the outer wall 134 to the bottom 112. This may provide for some ease of use when installed at the rounded edge may be less likely to cause the horse to stumble.

Along the “inside” of the horseshoe 100 is an inner wall 130. The inner wall may have a bevel 132 where it joins the bottom 114. In some embodiments, the bevel 132 may be a radiused surface as well. It can be seen here than the bottom 114 provides a flat 138 between the radius 136 and bevel 132 into which the trench 118 is placed. The flat 138 may be substantially planar—that is straight when viewed from the side (e.g., as in FIGS. 2C-2D). The top 112 may be substantially planar as well (excepting the toe ramp 117) such that the angle between at least the flat 138 of the bottom 114 can be precisely defined as above.

It will be appreciated that many various sizes of horseshoe can be implemented using the present disclosure. So long as the requisite “uphill” angle of the shoe is maintained, the width, length, and other dimensions of the horseshoe can be adjusted to fit various equine hooves. Nevertheless, certain sizes are standard. Exact dimensions for representative sizes are provided in the Figures discussed below. However, these sizes are not necessarily limiting to the claimed subject matter of the present disclosure.

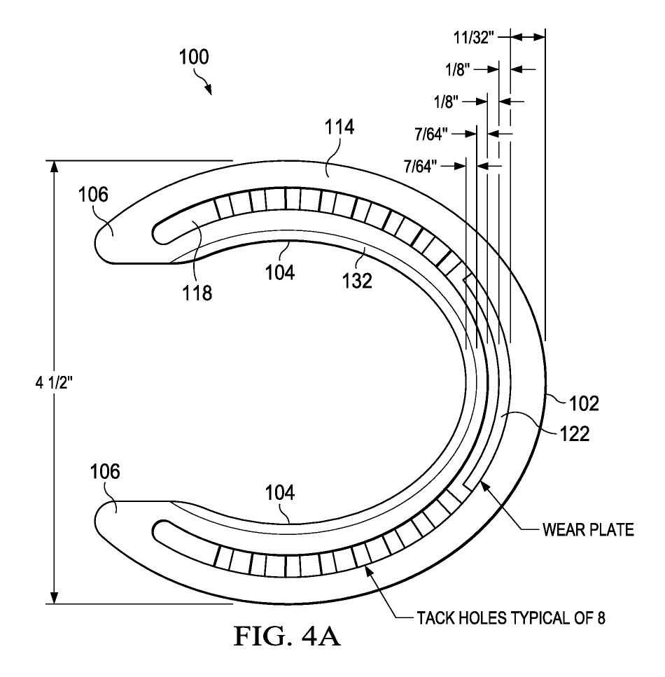

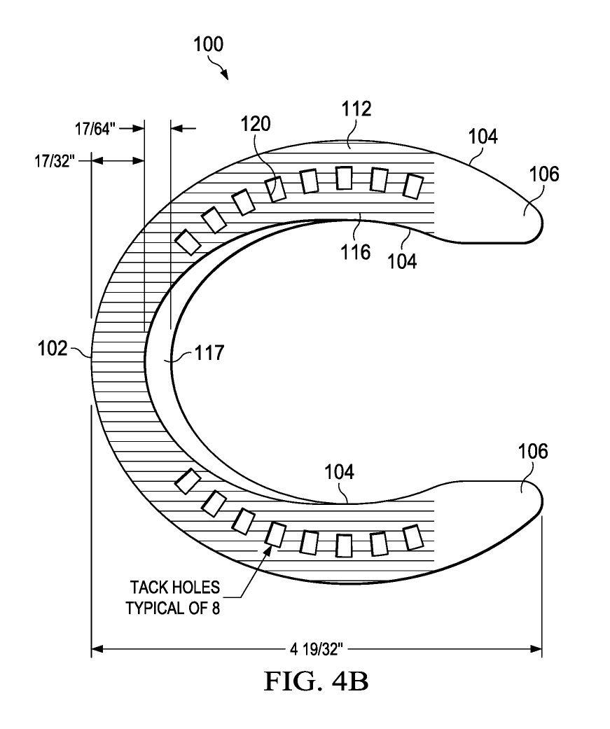

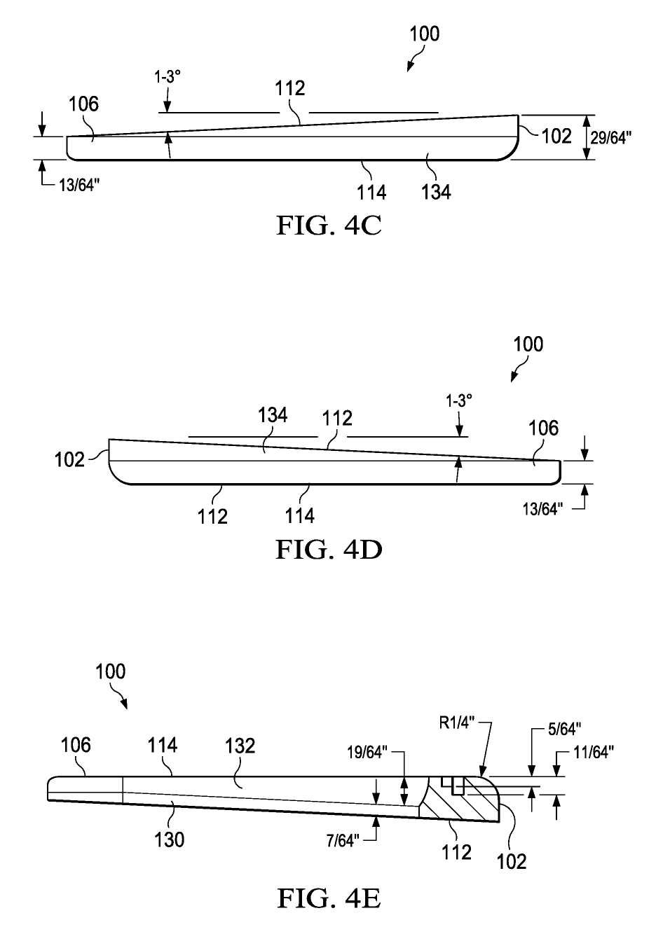

FIG. 4A is an inferior plan view of one embodiment of a therapeutic horseshoe according to aspects of the present disclosure in size 00. FIG. 4B is a superior plan view of the horseshoe of FIG. 4A. FIG. 4C is a side view of the horseshoe of FIG. 4A. FIG. 4D is a side view of the horseshoe of FIG. 4A opposite of FIG. 4C. FIG. 4E is a side cutaway view of the horseshoe of FIG. 4A.

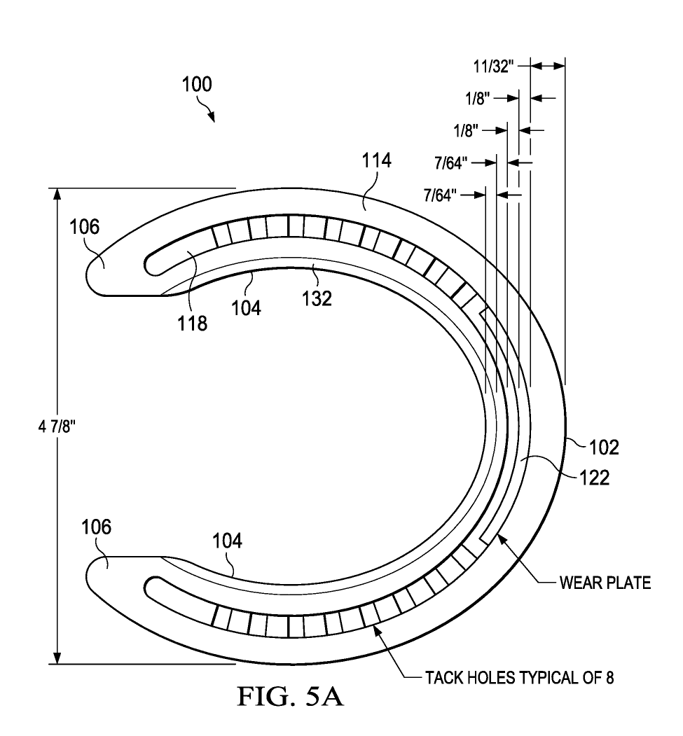

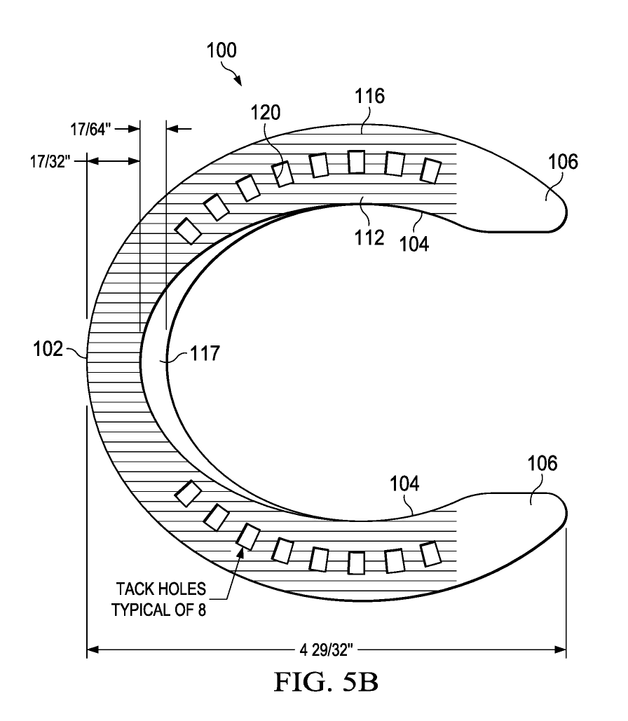

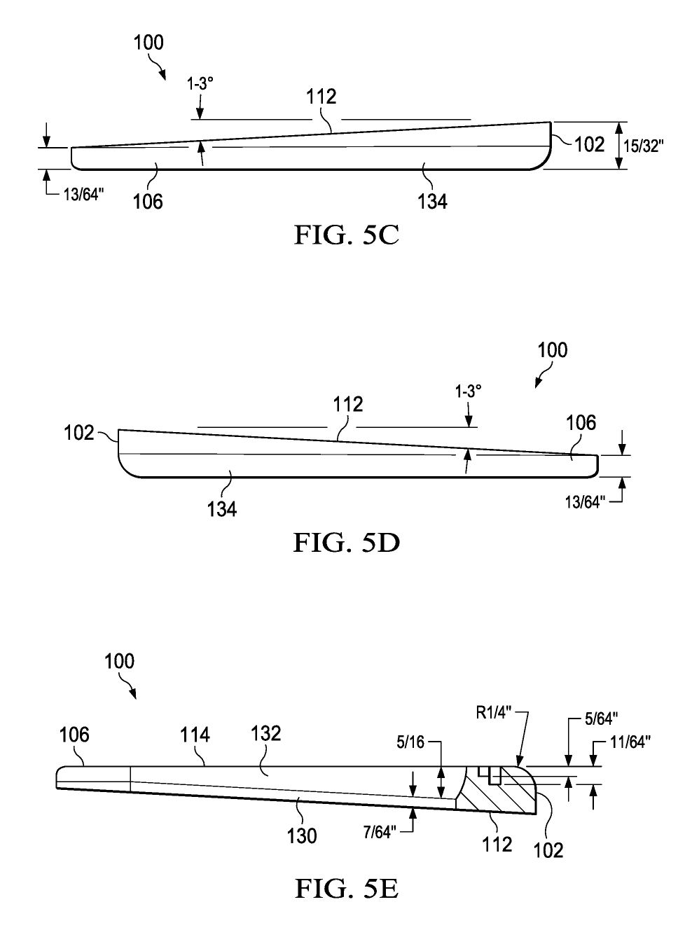

FIG. 5A is an inferior plan view of one embodiment of a therapeutic horseshoe according to aspects of the present disclosure in size 0. FIG. 5B is a superior plan view of the horseshoe of FIG. 5A. FIG. 5C is a side view of the horseshoe of FIG. 5A. FIG. 5D is a side view of the horseshoe of FIG. 5A opposite of FIG. 5C. FIG. 5E is a side cutaway view of the horseshoe of FIG. 5A.

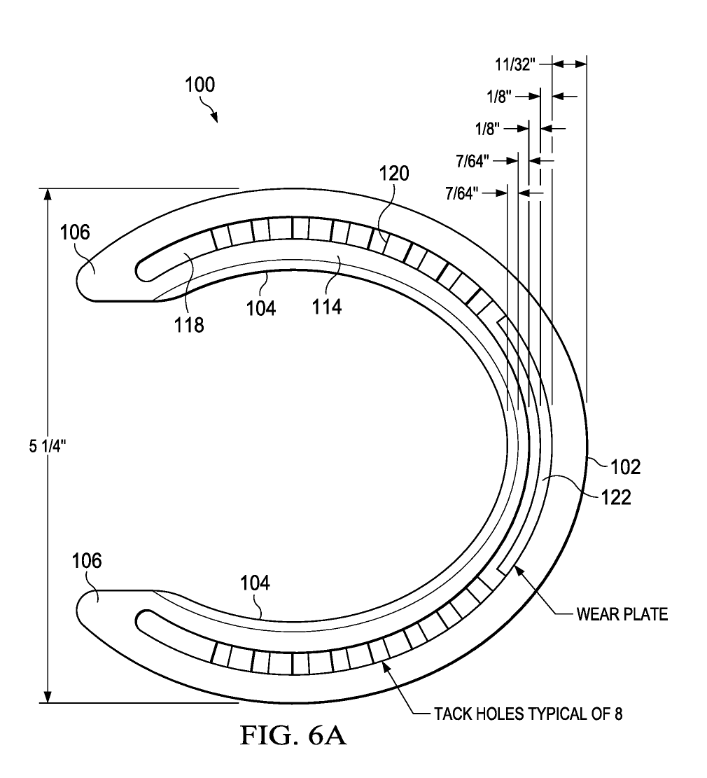

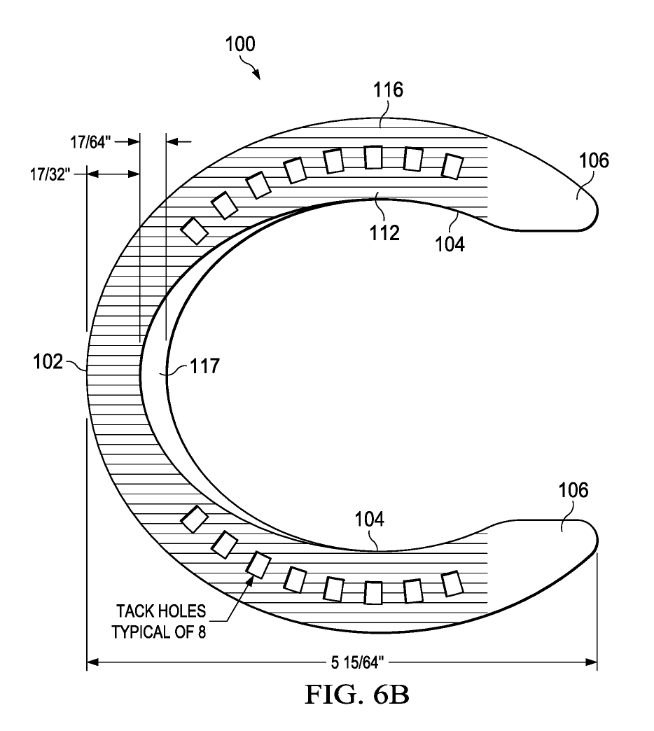

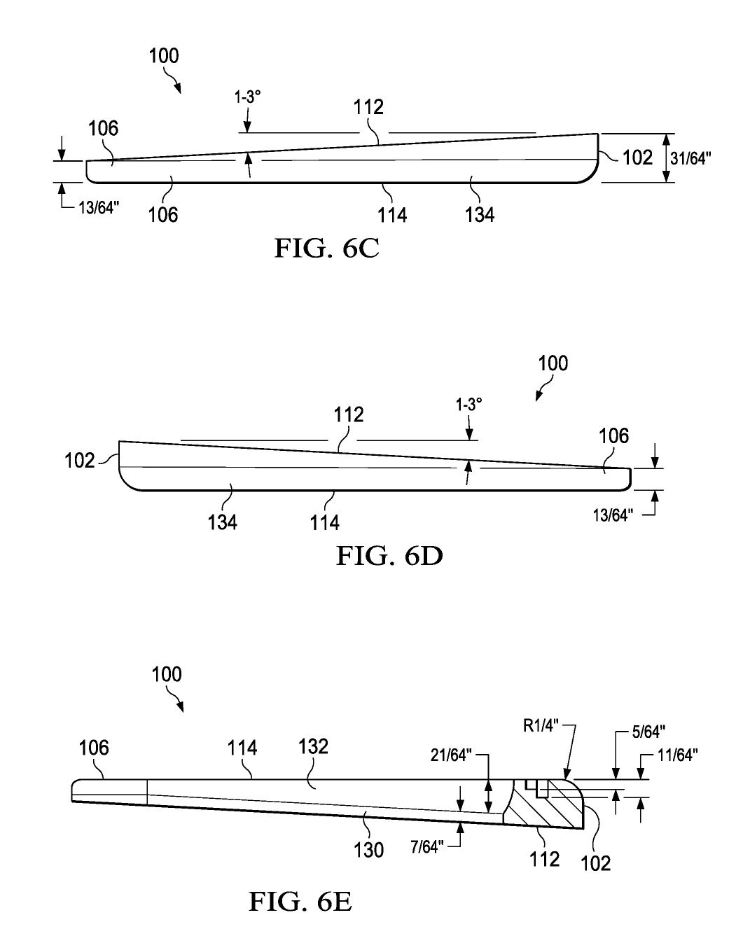

FIG. 6A is an inferior plan view of one embodiment of a therapeutic horseshoe according to aspects of the present disclosure in size 1. FIG. 6B is a superior plan view of the horseshoe of FIG. 6A. FIG. 6C is a side view of the horseshoe of FIG. 6A. FIG. 6D is a side view of the horseshoe of FIG. 6A opposite of FIG. 6C. FIG. 6E is a side cutaway view of the horseshoe of FIG. 6A.

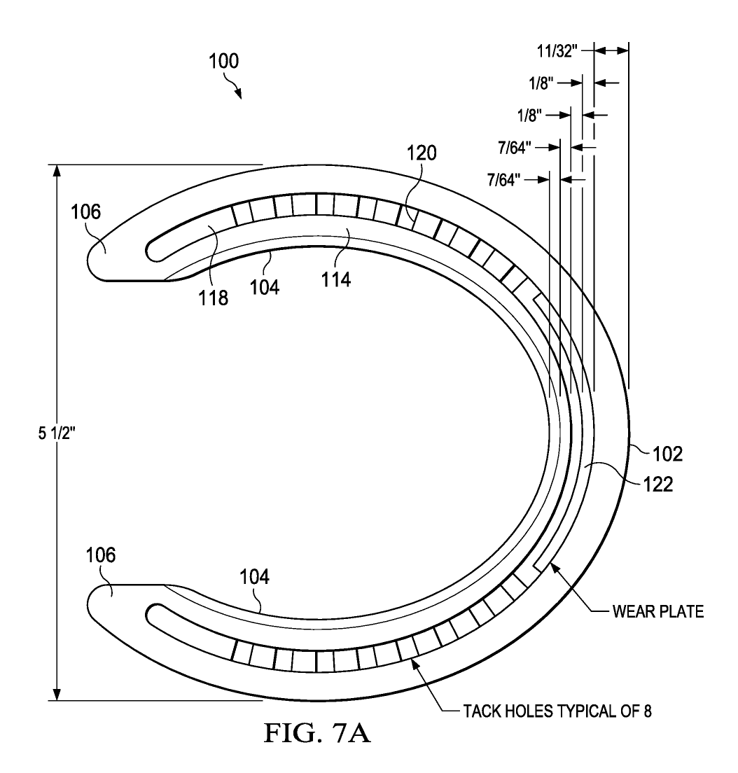

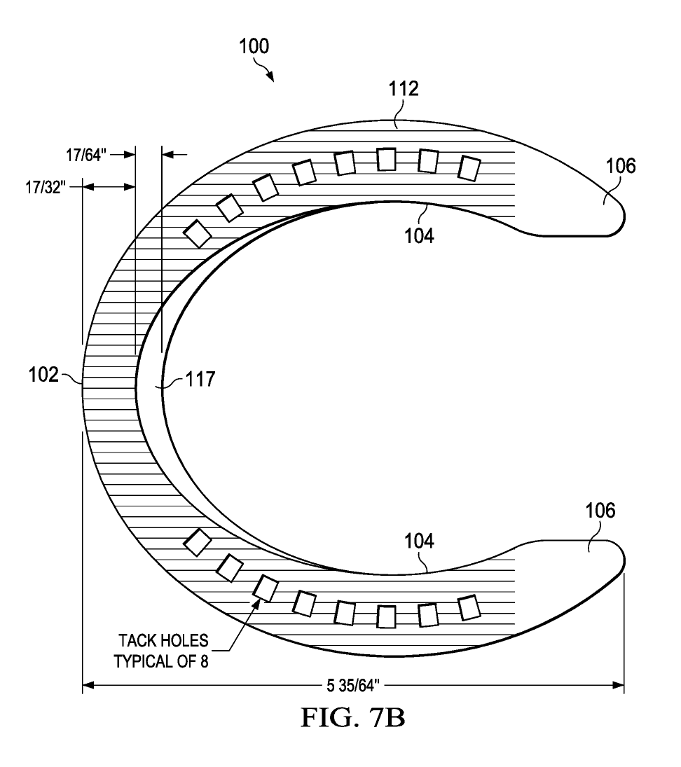

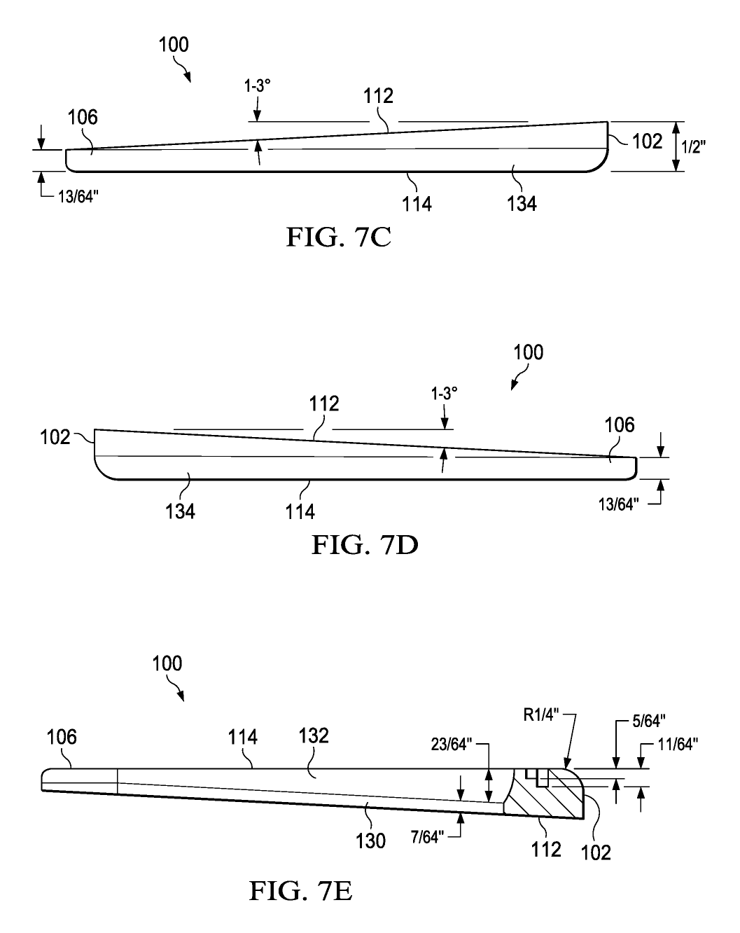

FIG. 7A is an inferior plan view of one embodiment of a therapeutic horseshoe according to aspects of the present disclosure in size 2. FIG. 7B is a superior plan view of the horseshoe of FIG. 7A. FIG. 7C is a side view of the horseshoe of FIG. 7A. FIG. 7D is a side view of the horseshoe of FIG. 7A opposite of FIG. 7C. FIG. 7E is a side cutaway view of the horseshoe of FIG. 7A.

In some embodiments, the shoe 100 comprises aluminum with a steel wear plate 122. However, the wear plate 122 may not be provided in all embodiments, or may comprise a different material than steel. Additionally, the entire shoe can be made from steel but the weight of the shoe may be suboptimal (e.g., too heavy). Additionally, polymers could be used in the construction of the shoe 100 where suitably durability and wear can be provided by the material.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A horseshoe comprising:
a toe connecting to two branches that arc toward a heel;
a top of the toe and two branches providing a mating surface for contacting an equine hoof;
a bottom of the toe and two branches defining a recessed trench and plurality of tack holes inside the trench passing through the branches to the top;
wherein the top and bottom are planar along at least a portion thereof and the top is angled away from the bottom from heel to toe at a continuous predetermined angle.

2. The horseshoe of claim 1, wherein the predetermined angle is about 1 degree.

3. The horseshoe of claim 1, wherein the predetermined angle is about 2 degrees.

4. The horseshoe of claim 1, wherein the predetermined angle is about 3 degrees.

5. The horseshoe of claim 1, wherein the trench is defined through both branches and the toe.

6. The horseshoe of claim 5, further comprising a wear plate placed into the trench at the toe.

7. The horseshoe of claim 6, wherein the wear plate comprises a different material than the rest of the horseshoe.

8. A horseshoe comprising:
a toe adjoining to two branches that bend away from the toe and terminate in a heel;
an at least partially planar top surface of the adjoined toe and two branches; and
an at least partially planar bottom surface of the adjoined toe and two branches;
wherein the top surface and bottom surface are angled together such that they are closer in proximity at the heel than the toe.

9. The horseshoe of claim 8, wherein the top surface and bottom surface are angled together at least one degree.

10. The horseshoe of claim 8, wherein the top surface and bottom surface are angled together at least two degrees.

11. The horseshoe of claim 8, wherein the top surface and bottom surface are angled together at least three degrees.

12. A method comprising:
preparing a hoof to accept an equine shoe;
providing a shoe comprising a top surface, a bottom surface, a toe and a heel, the top surface adapted to fit the hoof and the top and bottom surface being angled toward one another at a predetermined angle to be closer together at the heel than the toe;
fixing the shoe to the hoof.

13. The method of claim 12, wherein providing the shoe comprising providing a shoe with a predetermined angle of about 1 degree.

14. The method of claim 12, wherein providing the shoe comprising providing a shoe with a predetermined angle of about 2 degrees.

15. The method of claim 12, wherein providing the shoe comprising providing a shoe with a predetermined angle of about 3 degrees.

16. The method of claim 12 wherein fixing the shoe to the hoof comprises nailing the shoe to a keratinized portion of the hoof.

17. The method of claim 16, wherein providing a shoe further comprises providing a shoe with a trench cut into the bottom surface and defining a plurality of nail holes.
